(19) United States
(12) Patent Application Publication
(10) Pub. No.: US 2010/0070596 A1
(43) Pub. Date: Mar. 18, 2010

(54) INFORMATION PROVIDING SYSTEM, INFORMATION MANAGEMENT SERVER, INFORMATION MANAGEMENT METHOD AND INFORMATION MANAGEMENT PROGRAM

(75) Inventor: Tomoo Watanabe, Saitama (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/531,531

(22) PCT Filed: Mar. 23, 2007
(86) PCT No.: PCT/JP2007/056067

§ 371 Date: Sep. 16, 2009

(51) Int. Cl. G06F 15/16

(52) U.S. Cl. 709/206; 709/217

(57) ABSTRACT

An information management server includes an information provision request receiving unit which receives an information provision request together with request information, a probe information provision requesting unit which performs the probe information provision request to the probe information providing apparatus, a probe information obtaining unit which obtains the probe information from the probe information providing apparatus, a message information provision requesting unit which performs the message information provision request to the message information providing apparatus, a message information obtaining unit which obtains the message information from the message information providing apparatus, a response-to-request information generating unit which generates response-to-request information corresponding to the request information by using the probe information and the message information, and a response-to-request information providing unit which provides the response-to-request information to the information provision requesting apparatus.

### TECHNICAL FIELD

The present invention relates to a technique of providing information corresponding to an information request from an apparatus which is not located on a site.

### BACKGROUND TECHNIQUE

Conventionally, there is proposed a community area information providing system which provides information corresponding to an information provision request from a device which is not located on a site (for example, see. Patent Reference-1). Specifically, when a user terminal transmits a format, in which information is inputted, to an information device, the information device transmits an information transmitting request to an information obtaining device (for example, a camera) which matches the contents inputted to the format, and provides the information obtained from the information obtaining device to the user terminal.

Patent Reference-1: Japanese Patent Application Laid-open under No. 2005-11091

### DISCLOSURE OF INVENTION

### Problem to be Solved by the Invention

However, in the above community area information providing device, there is such a problem that the user terminal can obtain only the information from the information device and the amount of information is not necessarily sufficient.

The above is an example of a problem to be solved by the present invention. It is an object of the present invention to provide an information providing system capable of providing diversified information.

### Means for Solving the Problem

According to an invention described in claim 1, an information management server includes: an information provision request receiving means which receives an information provision request, together with request information, from an information provision requesting apparatus; a requested probe information providing apparatus determining means which determines a probe information providing apparatus to which a probe information provision request is performed; a probe information provision requesting means which performs the probe information provision request to the probe information providing apparatus determined by the requested probe information providing apparatus determining means; a probe information obtaining means which obtains the probe information from the probe information providing apparatus; a requested message information providing apparatus determining means which determines a message information providing apparatus to which a message information provision request is performed; a message information provision requesting means which performs the message information provision request to the message information providing apparatus determined by the requested message information providing apparatus determining means; a message information obtaining means which obtains the message information from the message information providing apparatus; a response-to-request information generating means which generates response-to-request information corresponding to the request information by using the probe information and the message information; and a response-to-request information providing means which provides the response-to-request information to the information provision requesting apparatus.

According to an invention described in claim 6, an information management method includes: an information provision request receiving process which receives an information provision request, together with request information, from an information provision requesting apparatus; a requested probe information providing apparatus determining process which determines a probe information providing apparatus to which a probe information provision request is performed; a probe information provision requesting process which performs the probe information provision request to the probe information providing apparatus determined by the requested probe information providing apparatus determining process; a probe information obtaining process which obtains the probe information from the probe information providing apparatus; a requested message information providing apparatus determining process which determines a message information providing apparatus to which a message information provision request is performed; a message information provision requesting process which performs the message information provision request to the message information providing apparatus determined by the requested message information providing apparatus determining process; a message information obtaining process which obtains the message information from the message information providing apparatus; a response-to-request information generating process which generates response-to-request information corresponding to the request information by using the probe information and the message information; and a response-to-request information providing process which provides the response-to-request information to the information provision requesting apparatus.

According to an invention described in claim 7, an information management program, executed by an apparatus including a computer, makes the computer function as: an information provision request receiving means which receives an information provision request, together with request information, from an information provision requesting apparatus; a requested probe information providing apparatus determining means which determines a probe information providing apparatus to which a probe information provision request is performed; a probe information provision requesting means which performs the probe information provision request to the probe information providing apparatus determined by the requested probe information providing apparatus determining means; a probe information obtaining means which obtains the probe information from the probe information providing apparatus; a requested message information providing apparatus determining means which determines a message information providing apparatus to which a message information provision request is performed; a message information provision requesting means which performs the message information provision request to the message information providing apparatus determined by the requested message information providing apparatus determining means; a message information obtaining means which obtains the message information from the message information providing apparatus; a response-to-request information generating means which generates response-to-request information corresponding to the request information by using the probe information and the message information; and a response-to-request information providing means which provides the response-to-request information to the information provision requesting apparatus.

According to an invention described in claim 9, an information providing system includes an information provision requesting apparatus, an information management server, a probe information providing apparatus and a message information providing apparatus. The information provision requesting apparatus includes: an information provision requesting means which performs an information provision request, together with request information, to the information management server; and a response-to-request information obtaining means which obtains response-to-request information corresponding to the request information from the information management server. The information management server includes: an information provision request receiving means which receives the information provision request, together with the request information, from the information provision requesting apparatus; a requested probe information providing apparatus determining means which determines the probe information providing apparatus to which a probe information provision request is performed; a probe information provision requesting means which performs the probe information provision request to the probe information providing apparatus determined by the requested probe information providing apparatus determining means; a probe information obtaining means which obtains the probe information from the probe information providing apparatus; a requested message information providing apparatus determining means which determines the message information providing apparatus to which a message information provision request is performed; a message information provision requesting means which performs the message information provision request to the message information providing apparatus determined by the requested message information providing apparatus determining means; a message information obtaining means which obtains the message information from the message information providing apparatus; a response-to-request information generating means which generates response-to-request information corresponding to the request information by using the probe information and the message information; and a response-to-request information providing means which provides the response-to-request information to the information provision requesting apparatus. The probe information providing apparatus includes a probe information providing means which provides probe information in response to the probe information provision request from the information management server, and the message information providing apparatus includes a message information providing means which provides message information in response to the message information provision request from the information management server.

### BRIEF DESCRIPTION OF THE DRAWINGS

FIG. 1 is a block diagram showing a schematic configuration of an information providing system;

FIGS. 2A to 2C show examples of request information;

FIG. 3 is a schematic diagram of a navigation apparatus;

FIG. 4 is a block diagram showing a schematic configuration of a probe information providing apparatus;

FIG. 5 is a block diagram showing a schematic configuration of an information management server;

FIG. 6 is a conceptual diagram showing data structure of owned device information DB;

FIGS. 7A and 7B show examples of response-to-request information;

FIG. 8 is a conceptual diagram showing data structure of an owner reliability information DB;

FIG. 9 is a flowchart of information provision requesting processing; and

FIG. 10 is a flowchart of information providing process.

### BRIEF DESCRIPTION OF THE REFERENCE NUMBER

1 Information Providing System
100 Information provision requesting apparatus
200 Information management server
300 Probe information providing apparatus
400 Navigation apparatus
500 Message information providing apparatus

### BEST MODE FOR EXERCISING THE INVENTION

According to one aspect of the present invention, there is provided an information management server including: an information provision request receiving means which receives an information provision request, together with request information, from an information provision requesting apparatus; a requested probe information providing apparatus determining means which determines a probe information providing apparatus to which a probe information provision request is performed; a probe information provision requesting means which performs the probe information provision request to the probe information providing apparatus determined by the requested probe information providing apparatus determining means; a probe information obtaining means which obtains the probe information from the probe information providing apparatus; a requested message information providing apparatus determining means which determines a message information providing apparatus to which a message information provision request is performed; a message information provision requesting means which performs the message information provision request to the message information providing apparatus determined by the requested message information providing apparatus determining means; a message information obtaining means which obtains the message information from the message information providing apparatus; a response-to-request information generating means which generates response-to-request information corresponding to the request information by using the probe information and the message information; and a response-to-request information providing means which provides the response-to-request information to the information provision requesting apparatus.

Specifically, the above information management server may be formed as a server apparatus. The request receiving means receives the information provision request, together with request information, from the information provision requesting apparatus. The requested probe information providing apparatus determining means determines the probe information providing apparatus to which the probe information provision request is performed. The probe information is information relating to operation and/or circumstance situation of each of various apparatuses, and may specifically includes information relating to the operation of the vehicle obtained via the vehicle, or picture data around the electric pole captured by a camera mounted on the electric pole. The probe information provision requesting means performs the probe information provision request to the probe information providing apparatus determined by the requested probe information providing apparatus determining means. The probe information obtaining means obtains the probe information transmitted from the probe information providing apparatus. Thereby, the information management server can obtain probe information.

The requested message information providing apparatus determining means determines the message information providing apparatus to which the message information provision request is performed. The message information indicates message inputted by the input operation of the user of the message information providing apparatus. Specifically, the message information may be a mail of a cell-phone. The message information provision requesting means performs the message information provision request to the message information providing apparatus determined by the requested message information providing apparatus determining means. The message information obtaining means obtains the message information transmitted from the message information providing apparatus. Thereby, the information management server can obtain the message information.

The response-to-request information generating means generates the response-to-request information by using the probe information and the message information. Then, the response-to-request information providing means provides the response-to-request information to the information provision requesting apparatus.

As described above, the information management server generates the response-to-request information corresponding to the request information by using the probe information and the message information, and provides the response-to-request information to the information provision requesting apparatus. Therefore, the information management server can provide information more specifically than the case where only the probe information is simply provided, and can provide information to the user of the information providing apparatus in an easily understand able manner.

In one mode of the information management server, the request information limits an information obtaining range, the information provision request receiving means determines a region corresponding to the information obtaining range, the requested probe information providing apparatus determining means determines the prove information providing apparatus located in the region as the probe information providing apparatus to which the probe information provision request is performed, and the requested message information providing apparatus determining means determines the message information providing apparatus located in the region as the message information providing apparatus to which the message information provision request is performed. In this case, it can be prevented that the information management server obtains unnecessary probe information.

An other mode of the information management server further includes an owned device information storing means which stores owned device information defining correspondence between the probe information providing apparatus and an owner of the probe information providing apparatus and correspondence between the message information providing apparatus and an owner of the message information providing apparatus, and the requested message information providing apparatus determining means refers to the owned device information and eliminates the message information providing apparatus, owned by the owner of the probe information providing apparatus which has provided the probe information, from an object of the information provision request.

As described above, the information management server does not perform the message information provision request to the message information providing apparatus, which is owned by an owner of the probe information providing apparatus that has transmitted the probe information. Thereby, it can be prevented that the information management server performs the information provision request to the apparatus of the same owner for a plurality of times.

According to another mode of the information management server, the owned device information includes an priority order for a plurality of the message information providing apparatuses owned by a same owner, and the requested message information providing apparatus determining means determines whether or not to perform the information provision request to the message information providing apparatus having high priority order in the owned device information when the same owner owns the plurality of the message information providing apparatuses. In this case, the information management server can perform the message information provision request to the message information providing apparatus having high possibility of providing information. Therefore, the information management server can provide useful response-to-request information.

Still another mode of the information management server further includes: an owner reliability information storing means which stores owner reliability information defining correspondence between the owner of the message information providing apparatus which has transmitted the message information and reliability of the message information, and an owner reliability information updating means which updates the owner reliability information based on reliability information defining the reliability of the message information in the response-to-request information, wherein the response-to-request information generating means selects the message information to be included in the response-to-request information based on the owner reliability information. Here, the reliability indicates the reliability of the contents of the message information transmitted by the user of the message information providing apparatus. In accordance with the input operation of the user of the information provision requesting apparatus, the reliability is set for each of the message information. For example, when the message information providing apparatus transmits useful message information, a high reliability is set to the user of that message information providing apparatus. When the reliability corresponding to the user who has transmitted the message information is transmitted to the information management server, the owner reliability information updating means updates the reliability information of the owner reliability information based on the transmitted reliability information. In this case, by referring to the owner reliability information to include message information only received from the owners having high reliability to the response-to-request information, information having high quality and quantity can be provided.

According to another aspect of the present invention, there is provided an information management method including: an information provision request receiving process which receives an information provision request, together with request information, from an information provision requesting apparatus; a requested probe information providing apparatus determining process which determines a probe information providing apparatus to which a probe information provision request is performed; a probe information provision requesting process which performs the probe information provision request to the probe information providing apparatus determined by the requested probe information providing apparatus determining process; a probe information obtaining process which obtains the probe information from the probe information providing apparatus; a requested message information providing apparatus determining process which determines a message information providing apparatus to which a message information provision request is performed; a message information provision requesting process which performs the message information provision request to the message information providing apparatus determined by the requested message information providing apparatus determining process; a message information obtaining process which obtains the message information from the message information providing apparatus; a response-to-request information generating process which generates response-to-request information corresponding to the request information by using the probe information and the message information; and a response-to-request information providing process which provides the response-to-request information to the information provision requesting apparatus.

Also by this method, the response-to-request information is generated by using the probe information and the message information, and the response-to-request information is provided to the information provision requesting apparatus. Therefore, it is possible to provide information more specifically than the case where only the probe information is simply provided, and to provide information to the user of the information providing apparatus in an easily understand able manner.

According to still another aspect of the present invention, there is provided an information management program executed by an apparatus including a computer, the program makes the computer function as: an information provision request receiving means which receives an information provision request, together with request information, from an information provision requesting apparatus; a requested probe information providing apparatus determining means which determines a probe information providing apparatus to which a probe information provision request is performed; a probe information provision requesting means which performs the probe information provision request to the probe information providing apparatus determined by the requested probe information providing apparatus determining means; a probe information obtaining means which obtains the probe information from the probe information providing apparatus; a requested message information providing apparatus determining means which determines a message information providing apparatus to which a message information provision request is performed; a message information provision requesting means which performs the message information provision request to the message information providing apparatus determined by the requested message information providing apparatus determining means; a message information obtaining means which obtains the message information from the message information providing apparatus; a response-to-request information generating means which generates response-to-request information corresponding to the request information by using the probe information and the message information; and a response-to-request information providing means which provides the response-to-request information to the information provision requesting apparatus.

By executing the program on various apparatuses, the information management server of the present invention can be realized. The information management program can be preferably handled in a manner recorded on a storage medium.

According to still another aspect of the present invention, there is provided an information providing system including an information provision requesting apparatus, an information management server, a probe information providing apparatus and a message information providing apparatus. The information provision requesting apparatus includes: an information provision requesting means which performs an information provision request, together with request information, to the information management server; and a response-to-request information obtaining means which obtains response-to-request information corresponding to the request information from the information management server. The information management server includes: an information provision request receiving means which receives the information provision request, together with the request information, from the information provision requesting apparatus; a requested probe information providing apparatus determining means which determines the probe information providing apparatus to which a probe information provision request is performed; a probe information provision requesting means which performs the probe information provision request to the probe information providing apparatus determined by the requested probe information providing apparatus determining means; a probe information obtaining means which obtains the probe information from the probe information providing apparatus; a requested message information providing apparatus determining means which determines the message information providing apparatus to which a message information provision request is performed; a message information provision requesting means which performs the message information provision request to the message information providing apparatus determined by the requested message information providing apparatus determining means; a message information obtaining means which obtains the message information from the message information providing apparatus; a response-to-request information generating means which generates response-to-request information corresponding to the request information by using the probe information and the message information; and a response-to-request information providing means which provides the response-to-request information to the information provision requesting apparatus. The probe information providing apparatus includes a probe information providing means which provides probe information in response to the probe information provision request from the information management server. The message information providing apparatus includes a message information providing means which provides message information in response to the message information provision request from the information management server.

In the above system, the information provision requesting apparatus performs the information provision request to the information management server. The information management server obtains the probe information from the probe information providing apparatus and obtains the message information from the message information providing apparatus, in response to the information provision request. Then, the information management server generates the response-to-request information by using the probe information and the message information, and transmits the response-to-request information to the information management server. The information management server transmits the response-to-request information to the information provision requesting apparatus.

In this way, the information management server generates the response-to-request information by using the probe information and the message information, and provides the response-to-request information to the information provision requesting apparatus. Therefore, the information management server can provide information more specifically than the case where only the probe information is simply provided, and can provide information to the user of the information providing apparatus in an easily understand able manner.

### EMBODIMENT

Now, a description will be given of a preferred embodiment of the present invention with reference to attached drawings.

[Schematic Configuration of Information Providing System]

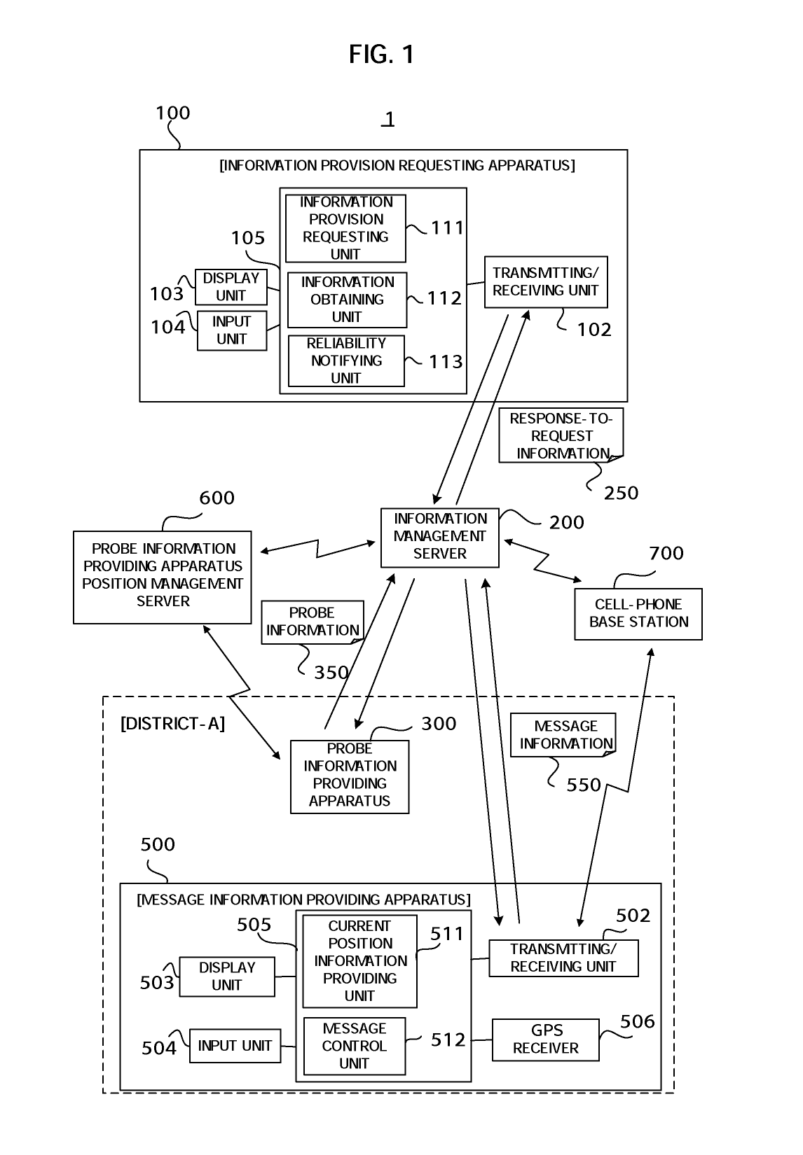

FIG. 1 shows a schematic diagram of an information providing system 1. In this embodiment, the information providing system 1 includes an information provision requesting apparatus 100, an information management server 200, a probe information providing apparatus 300, a message information providing apparatus 500, a probe information providing apparatus position management server 600 and a cell-phone base station 700.

The information provision requesting apparatus 100 includes a transmitting/receiving unit 102, a display unit 103, an input unit 104 and a control unit 105. Specifically, the control unit 105 may be a CPU, and totally controls the information provision requesting apparatus 100 in its entirety. The control unit 105 includes an information provision requesting unit 111, an information obtaining unit 112 and a reliability notifying unit 113. Namely, by the control unit 105 executing a predetermined program, the information provision requesting unit 111, the information obtaining unit 112 and the reliability notifying unit 112 are realized. It is noted that the information obtaining unit 112 in this embodiment functions as a response-to-request information obtaining means.

The transmitting/receiving unit 102 transmits and receives data. Specifically, the transmitting/receiving unit 102 transmits request information 150 and receives the response-to-request information 250 transmitted by the information management server 200.

The display unit 103 displays the result that a user operates the input unit 104, and the response-to-request information 250 obtained from the information management server 200.

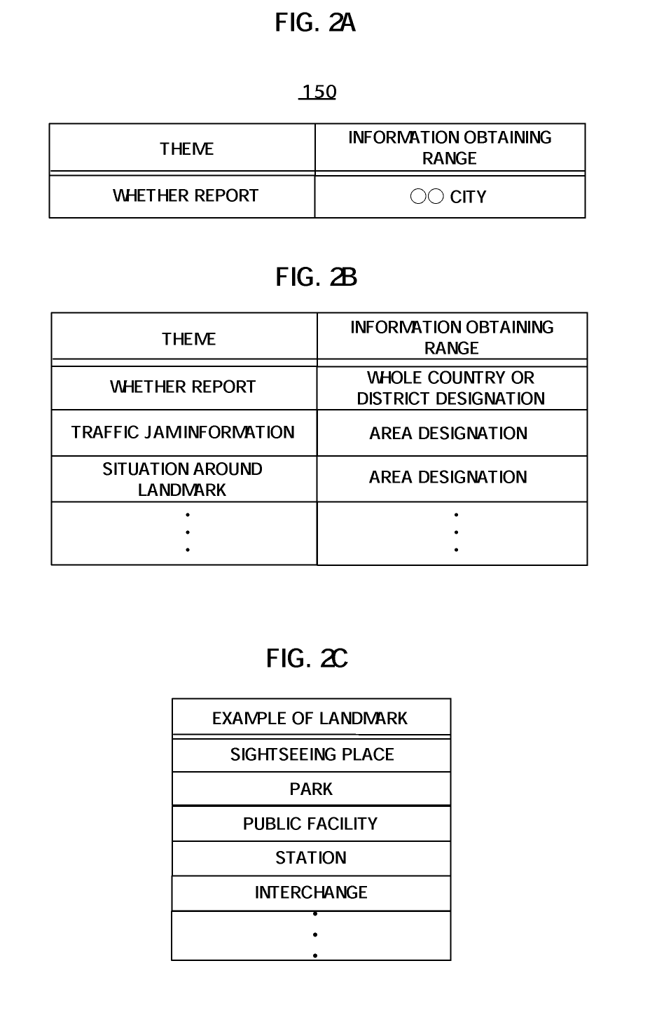

The information provision requesting unit 111 generates the request information 150 necessary to request the information provision in accordance with the operation of the input unit 104 by the user. Here, the request information 150 includes the theme of the object of the request and the information obtaining range, as shown in FIG. 2A.

The examples of the theme and the information obtaining range are shown in FIG. 2B. If the information obtaining range corresponding to the theme of the information provision request is “Area Designation” or “District Designation”, the information provision requesting unit 111 automatically set the area or the district, or asks the user to input the area or the district.

The “Landmark” in the “Around Landmark” in FIG. 2B means a sightseeing place, a park and so on, as shown in FIG. 2C.

When the information provision requesting unit 111 determines the theme of the object of the request and the information obtaining range, it generates the request information 150 based on the theme and the information obtaining range, and transmits the request information 150 to the information management server 200 via the transmitting/receiving unit 102.

The information obtaining unit 112 obtains the response-to-request information 150 from the information management server 200, and displays the information on the display unit 103.

The response-to-request information 250 includes probe information 350 and message information 550. The probe information 350 relates to the operation of the vehicle, and is obtained through the vehicle. The message information 550 means the message inputted by the input operation of the user who uses the message information providing apparatus 500. Specifically, the message information 550 may be message information of e-mail.

After displaying the response-to-request information 250 obtained by the information obtaining unit 112, the information provision requesting apparatus 100 asks the user of the information provision requesting apparatus 100 to input the reliability of the message information 550 in the response-to-request information 250. The reliability indicates the reliability of the contents of the message information 550 transmitted by the user of the message information providing apparatus 500. For example, when the message information providing apparatus 500 transmits useful message information 550, high reliability is set to the user of the message information providing apparatus 500.

The reliability notifying unit 113 notifies, to the information management server 200, the reliability of the user of the message information 550 in the response-to-request information 250 obtained by the information obtaining unit 112.

When receiving the information provision request from the information provision requesting apparatus 100 together with the request information 150, the information management server 200 requests the probe information providing apparatus 300 to transmit the probe information 350 or requests the message information providing apparatus 500 to transmit the message information, in accordance with the contents of the request information 150.

Then, the information management server 200 generates the response-to-request information 250 by using the probe information 350 obtained from the probe information providing apparatus 300 and the message information 550 obtained from the message information providing apparatus 500, and transmits the response-to-request information 250 to the information provision requesting apparatus 100. The details of the information management server 200 will be described later.

The probe information providing apparatus 300 includes a navigation apparatus 400 therein. After obtaining the probe information 350 in response to the probe information transmitting request from the information management server 200, the probe information providing apparatus 300 transmits the probe information 350 to the information management server 200. The details of the probe information providing apparatus 300 will be described later.

The message information providing apparatus 500 is concretely a cell-phone and includes a transmitting/receiving unit 502, a display unit 503, an input unit 504, a control unit 505 and a GPS receiver 506. The control unit 505 is concretely a CPU, and totally controls the message information providing apparatus 500 in its entirety. The control unit 505 includes a current position information providing unit 511 and a message control unit 512. Namely, by the control unit 505 executing a predetermined program, the current position information providing unit 511 and the message control unit 512 are realized.

The transmitting/receiving unit 502 transmits and receives data. Specifically, the transmitting/receiving unit 502 transmits the message information 550. The display unit 503 displays the result that the user operates the input unit 504.

The GPS receiver 506 receives radio waves carrying downlink data including measurement data from a plurality of GPS satellites. The measurement data is used to detect the absolute position of the message information providing apparatus 500 itself from the latitude and longitude information.

The current position information providing apparatus 511 obtains, from the GPS receiver 506, the latitude and longitude information of the position where the message information providing apparatus 500 is located, and transmits the latitude and longitude information to the information management server 200. The current position information providing unit 511 may transmit the latitude and longitude information to the cell-phone base station 700.

The message control unit 512 generates the message information 550 by mail or else in accordance with the operation of the input unit 504 by the user, and transmits the message information 550 to the information management server 200.

The message control unit 512 functions as a message information providing means.

The probe information providing apparatus position management server 600 is a server apparatus, which manages the position of the each probe information providing apparatus 300. Specifically, the probe information providing apparatus position management server 600 obtains the position information from the probe information providing apparatus 300 to retain the position information, and transmits the position information of the probe information providing apparatus 300 after receiving the position information transmitting request of each probe information providing apparatus 300 from the information management server 200.

The cell-phone base station 700 manages the position of each message information providing apparatus 500. Specifically, the cell-phone base station 700 obtains the position information from the message information providing apparatus 500 to retain the position information, and transmits the position information of the message information providing apparatus 500 after receiving the position information transmitting request of each message information providing apparatus 500 from the information management server 200.

As described above, in response to the request from the information provision requesting apparatus 100, the information management server 200 obtains various information from the probe information providing apparatus 300 and the message information providing apparatus 500, generates the response-to-request information 250 by using the information, and transmits the response-to-request information 250 to the information provision requesting apparatus 100.

Thus, the information management server 200 provides the information provision requesting apparatus 100 with the response-to-request information 250 using the probe information 350 and the message information 550. Therefore, it is possible to more specifically provide information than the case where the probe information 350 is merely provided, and information can be given to the user of the information providing apparatus in an easily understand able manner.

It is noted that the probe information providing apparatus 300 is substantially realized by the elements of the navigation apparatus 400 described later.

[Navigation Apparatus]

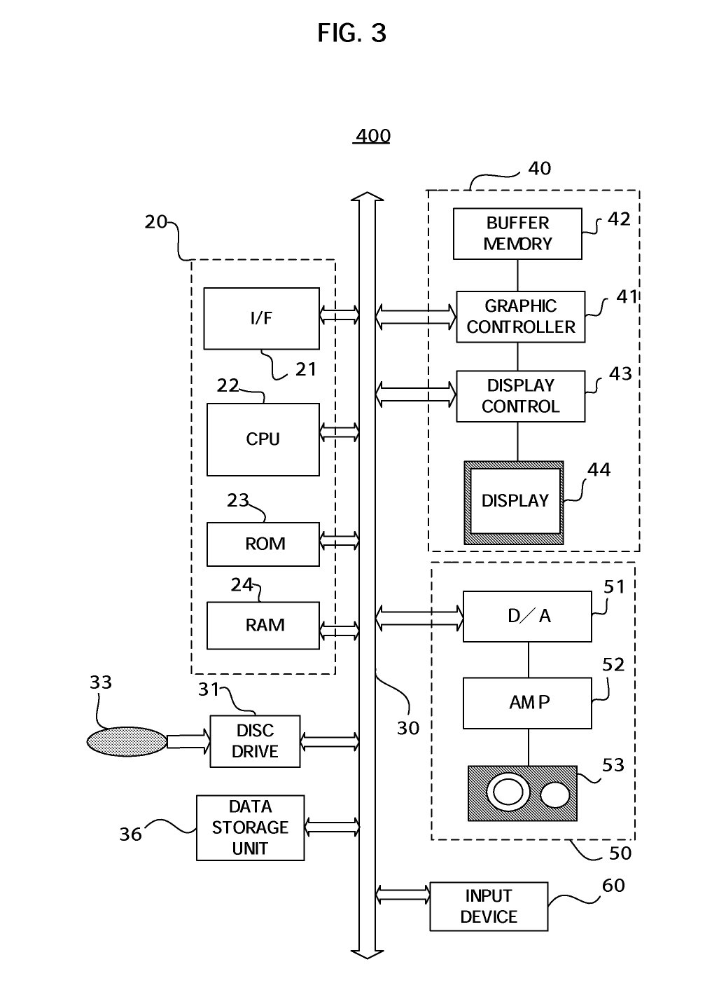

FIG. 3 shows a configuration of a navigation apparatus 400 according to an embodiment of the present invention. As shown in FIG. 3, the navigation apparatus 400 includes a system controller 20, a disc drive 31, a data storage unit 36, a display unit 40, a sound output unit 50, and an input device 60.

The system controller 20 includes an interface 21, a CPU 22, a ROM 23 and a RAM 24, and controls the navigation apparatus 400 in its entirety.

The interface 21 executes the interface operation with the stand-alone measurement device described later and the GPS receiver. Then, the interface 21 inputs the vehicle speed pulse, the acceleration data, the relative direction data, the angular velocity data, the GPS measurement data and the absolute direction data into the system controller 20. The CPU 22 controls the system controller 20 in its entirety. The ROM 23 includes a non-volatile memory (not shown) in which a control program for controlling the system controller 20 is stored. The RAM 24 readably stores various kinds of data such as route data preset by the user via the input device 60, and supplies a working area to the CPU 22.

The system controller 20, the disc drive 31 such as a CD-ROM drive or a DVD-ROM drive, the data storage unit 36, the display unit 40, the sound output unit 50 and the input device 60 are connected to each other via a bus line 30.

Under the control of the system controller 20, the disc drive 31 reads contents data such as sound data and video data from the disc 33 such as a CD and a DVD to output the contents data. The disc drive 31 may be the CD-ROM drive or the DVD-ROM drive, or may be a drive compatible between the CD and the DVD.

The data storage unit 36 may be a HDD, for example, and stores various kinds of data, such as map data and facility data, used for the navigation process.

The display unit 40 displays various kinds of display data on a display device such as a display under the control of the system controller 20. Concretely, the system controller 20 reads the map data from the data storage unit 36. The display unit 40 displays, on a display screen such as a display, the map data read from the data storage unit 36 by the system controller 20. The display unit 40 includes a graphic controller 41 for controlling the entire display unit 40 on the basis of the control data transmitted from the CPU 22 via the bus line 30, a buffer memory 42 having a memory such as a VRAM (VideoRAM) for temporarily storing immediately displayable image information, a display control unit 43 for controlling a display 44 such as a liquid crystal and a CRT (Cathode Ray Tube) on the basis of the image data outputted from the graphic controller 41, and the display 44. The display 44 is formed by a liquid crystal display device of the opposite angle 5-10 inches, and is mounted in the vicinity of a front panel of the vehicle compartment.

The sound output unit 50 includes a D/A converter 51 for executing D/A conversion of the sound digital data transmitted from the CD-ROM drive 31, a DVD-ROM 32 or the RAM 24 via the bus line 30 under the control of the system controller 20, an amplifier (AMP) 52 for amplifying a sound analog signal outputted from the D/A converter 51, and a speaker 53 for converting the amplified sound analog signal into the sound and outputting it to the vehicle compartment.

The input device 60 includes keys, switches, buttons, a remote controller and a sound input device, which are used for inputting various kinds of commands and data. The input device 60 is arranged in the vicinity of the display 44 and a front panel of a main body of an on-vehicle electric system loaded on the vehicle. Additionally, in such a case that the display 44 has a touch panel system, a touch panel provided on the display screen of the display 44 functions as the input device 60, too.

[Probe Information Providing Apparatus]

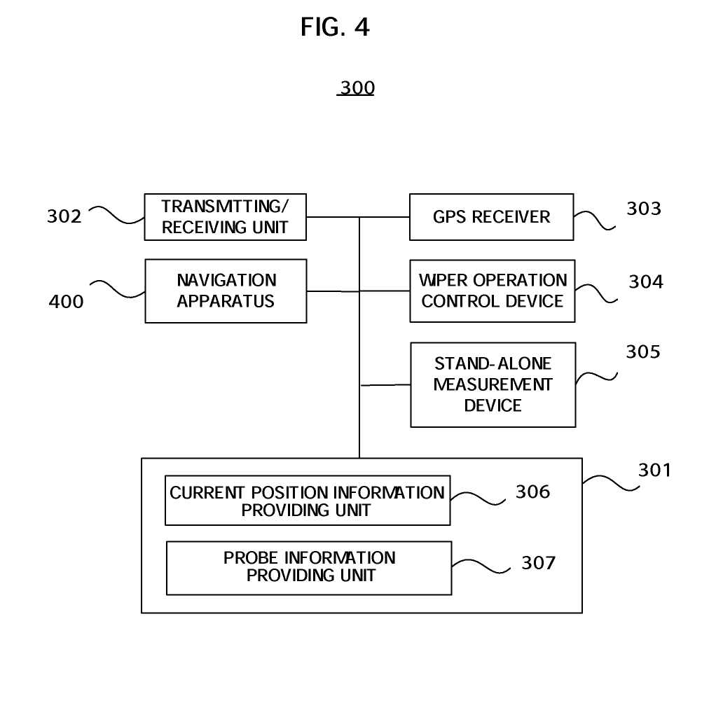

FIG. 4 shows a functional configuration of the probe information providing apparatus 300 which provides the probe information 350. The probe information providing apparatus 300 is installed on a mobile body such as a vehicle. As illustrated, the probe information providing apparatus 300 includes a control unit 301, a transmitting/receiving unit 302, a GPS receiver 303, a wiper operation control device 304, a stand-alone measurement device 305 and a navigation apparatus 400. Concretely, the control unit 301 is a CPU or the like, which totally controls the probe information providing apparatus 300 in its entirety. The control unit 301 includes a current position information providing unit 306 and a probe information providing unit 307. Namely, by executing the predetermined program, the control unit 301 realizes the current position information providing unit 306 and the probe information providing unit 307.

The transmitting/receiving unit 302 transmits and receives various information, and specifically transmits the probe information 350 to the information management server 200.

The GPS receiver 303 receives radio waves carrying downlink data including measurement data from a plurality of GPS satellites. The measurement data is used to detect the absolute position of the vehicle from the latitude and longitude information.

The wiper operation control device 304 controls the driving and stopping of the wiper not shown, and is operated by the driver.

The stand-alone measurement device 305 includes an acceleration sensor, an angular velocity sensor and a distance sensor. The acceleration sensor includes a piezoelectric element, for example, and detects the acceleration of the vehicle and outputs the acceleration data. The angular velocity sensor includes a gyroscope, for example, and detects the angular velocity of the vehicle when the vehicle turns the direction, and outputs the angular velocity data and the relative azimuth data. The distance sensor measures the vehicle speed pulses which are the pulse signals generated by the rotation of the wheels of the vehicle.

The current position information providing unit 306 obtains, from the GPS receiver 303, the latitude and longitude data of the position where the probe information providing apparatus 300 exists, and transmits the latitude and longitude information to the information management server 200. The current position information providing unit 306 may transmit the latitude and longitude information to the probe information providing apparatus position management server 600.

The probe information providing unit 307 obtains the wiper operating state from the wiper operation control device 304 and the speed information from the stand-alone measurement device 305, and transmits the wiper operating state and the speed information to the information management server 200 as the probe information 350.

In this way, when the current position information providing unit 306 transmits the current position information to the information management server 200 in response to the current position information transmission request from the information management server 200, the probe information providing apparatus 300 can notify the position of the probe information providing apparatus 300 to the information management server 200. In addition, when the probe information providing unit 307 transmits the probe information in response to the probe information transmission request from the information server 200, the probe information providing apparatus 300 can provide the probe information 350 to the information management server 200.

### [Information Management Server]

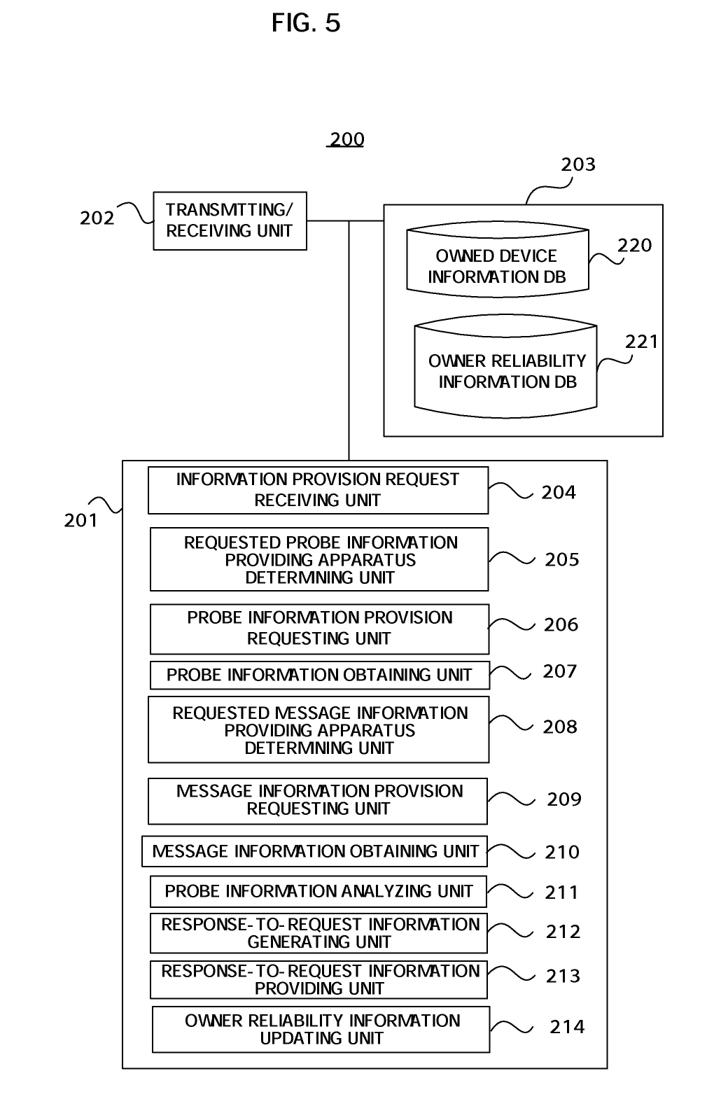

FIG. 5 shows a functional configuration of the information management server 200. Concretely, the information management server 200 is a server apparatus. As illustrated, the information management server 200 includes a control unit 201, a transmitting/receiving unit 202 and a storage unit 203. The storage unit 203 includes an owned device information DB 220 and an owner reliability information DB 221. The control unit 201 is concretely a CPU, which totally controls the information management server 200 in its entirety. The control unit 201 includes an information provision request receiving unit 204, a requested probe information providing apparatus determining unit 205, a probe information provision requesting unit 206, a probe information obtaining unit 207, a requested message information providing apparatus determining unit 208, a message information provision requesting unit 209, a message information obtaining unit 210, a probe information analyzing unit 211, a response-to-request information generating unit 213 and an owner reliability information updating unit 214. Namely, by executing a predetermined program, the control unit 201 realizes the information provision request receiving unit 204, the requested probe information providing apparatus determining unit 205, the probe information provision requesting unit 206, the probe information obtaining unit 207, the requested message information providing apparatus determining unit 208, the message information provision requesting unit 209, the message information obtaining unit 210, the probe information analyzing unit 211, the response-to-request information generating unit 213 and the owner reliability information updating unit 214.

The transmitting/receiving unit 202 transmits and receives various information such as the request information 150 and the probe information 350. The storage unit 203 stores the owned device information DB 220 and the owner reliability information DB 221. The storage unit 203 is concretely a harddisk or the like. The owned device information DB 220 is a database which defines the relationship between the probe information providing apparatus 300 and the message information providing apparatus 500 owned by each user.

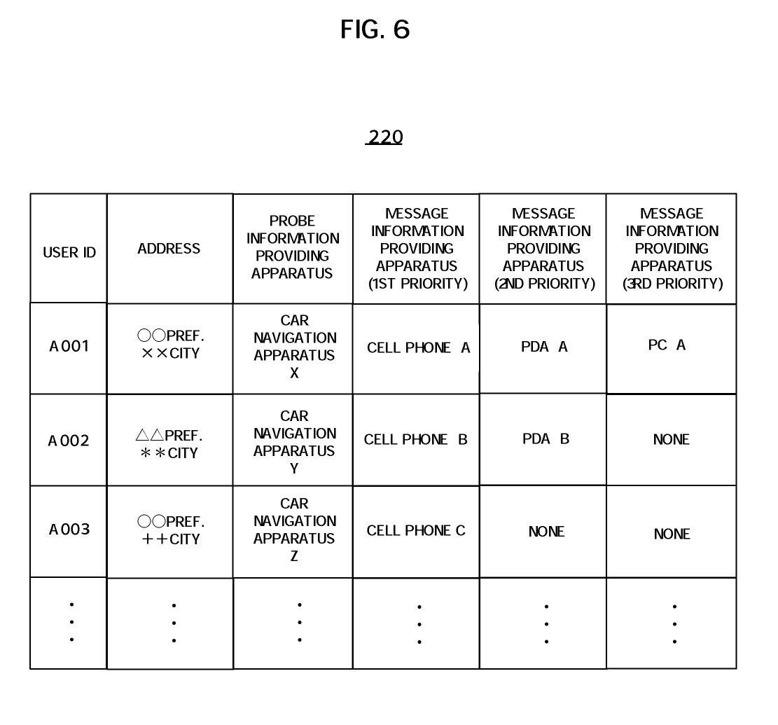

FIG. 6 shows an example of the owned device information DB 220. As illustrated, the owned device information DB 220 stores “USER ID” uniquely identifying the user, “ADDRESS” indicating the address of the user, “PROBE INFORMATION PROVIDING APPARATUS” indicating information related to the probe information providing apparatus 300, and “MESSAGE INFORMATION PROVIDING APPARATUS” indicating information related to the message information providing apparatus 500. As to the “MESSAGE INFORMATION PROVIDING APPARATUS”, plural information may be set and a priority order is defined to each of the plural “MESSAGE INFORMATION PROVIDING APPARATUS”.

“PROBE INFORMATION PROVIDING APPARATUS” and “MESSAGE INFORMATION PROVIDING APPARATUS” include destination information (e.g., mail address). The owner reliability information DB 221 will be described later.

The information provision request receiving unit 204 receives the information request from the information provision requesting apparatus 100. Then, the information provision request receiving unit 204 judges whether the information obtaining range of the request information 150 is the district designation or the area designation. The information provision request receiving unit 204 determines the region to obtain information, corresponding to the information obtaining range of the request information 150, if the information obtaining range of the request information is the district designation or the area designation.

The requested prove information providing apparatus determining unit 205 determines the probe information providing apparatus 300 to which the obtaining request of the probe information 350 is performed. Specifically, when the information obtaining range of the request information 150 is the district designation or the area designation, the requested probe information providing apparatus determining unit 205 obtains the position information from the probe information providing apparatus 300 registered in the owned device information DB 220, and determines the probe information providing apparatus 300 included in the region of the information request object determined by the information provision request receiving unit 204 as the probe information request object. When the information obtaining range of the request information 150 is neither the district designation nor the area designation, the requested probe information providing apparatus determining unit 205 determines all the probe information providing apparatus 300 as the probe information request object.

The probe information provision requesting unit 206 performs the provision request of the probe information 350 to the probe information providing apparatus 300 determined by the requested probe information providing apparatus determining unit 205. The probe information obtaining unit 207 obtains the probe information 350 transmitted by the probe information providing apparatus 300.

The requested message information providing apparatus determining unit 208 determines the message information providing apparatus 500 to which the obtaining request of the message information 550 is performed. Specifically, when the information obtaining range of the request information 150 is the district designation or the area designation, the requested message information providing apparatus determining unit 208 obtains the position information from the message information providing apparatus 500 having high priority order in the owned device information DB 220, out of the message information providing apparatuses 500 registered in the owned device information DB 220, and determines the message information providing apparatus 500 included in the region of the information request object determined by the information provision request receiving unit 204 as the message information request object. When the information obtaining range of the request information 150 is neither the district designation nor the area designation, the requested message information providing apparatus determining apparatus 208 determines the message information providing apparatus 500 having high priority order in the owned device information DB 220, out of the message information providing apparatuses 500 registered in the owned device information DB 220, as the message information request object.

Also, when the owner of the message information providing apparatus 500 is identical to the owner of the probe information providing apparatus 300 which has transmitted the probe information 350, the requested message information providing apparatus determining unit 208 eliminates the message information providing apparatus 500 from the message information request object.

The message information provision requesting unit 209 performs the obtaining request of the message information 550 to the message information providing apparatus 500 determined by the requested message information providing apparatus determining unit 208. The message information obtaining unit 210 obtains the message information 550 transmitted by the message information providing apparatus 500.

The probe information analyzing unit 211 analyses the probe information 350 that the probe information obtaining unit 207 obtains, and outputs the probe information analyzing result information 360 which is an analysis result of the probe information 350. Specifically, when the probe information 350 is the speed information, the probe information analyzing unit calculates the average value of the speed information obtained from each of the probe information providing apparatuses 300.

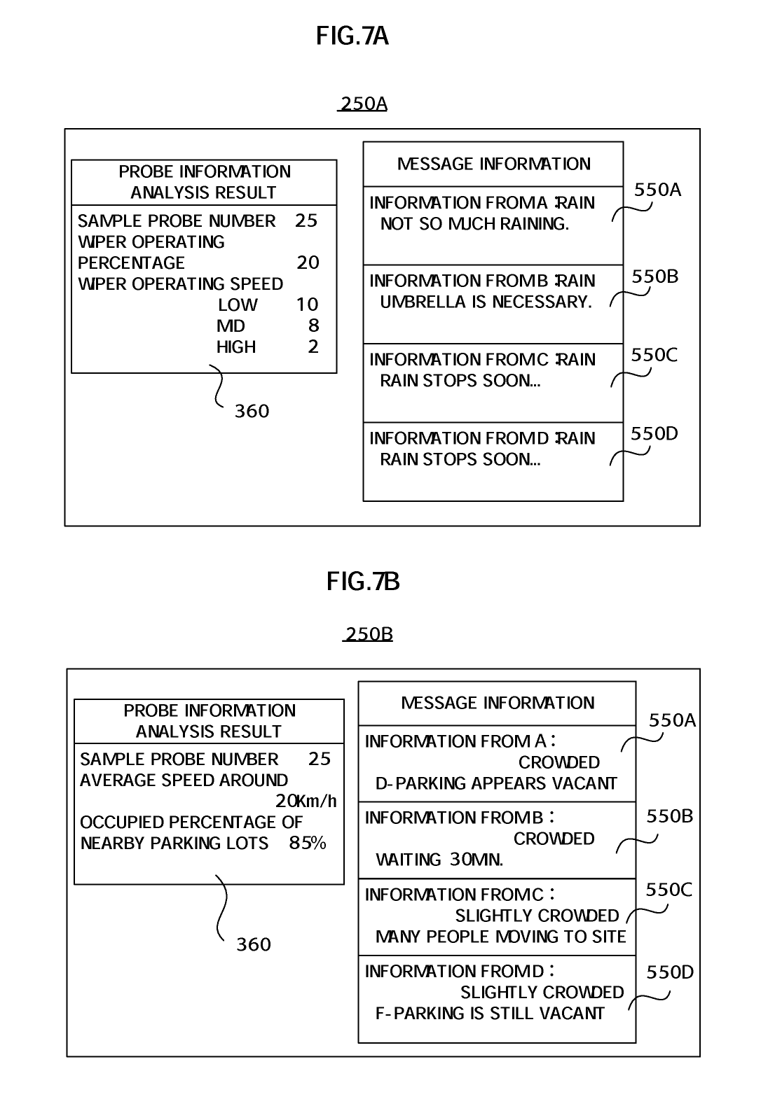

The response-to-request information generating unit 212 generates the response-to-request information 250 by using the probe information analyzing result information 360 and the message information 550. FIGS. 7A and 7B show examples of the response-to-request information 250.

The response-to-request information 250A shown in FIG. 7A is an example of the response-to-request information relating to weather report. In this case, the probe information analyzing result information 360 includes the number of the vehicles which provided the probe information 350, the wiper operating percentage and the wiper operating speed. The message information 550 (the message information 550A to 550B) include the messages relating to the weather, created by the users of the message information providing apparatuses 500.

The response-to-request information 250B shown in FIG. 7B is an example of the response-to-request information relating to the occupied state of parking lots. In this case, the probe information analyzing result information 360 includes the number of the vehicles that provided the probe information 360, the average speed around the vehicle and the occupied percentage of nearby parking lots. The message information 550 include the messages relating to the parking state inputted by the users of the message information providing apparatuses 500.

As described above, the information management server 200 can provide the information provision requesting apparatus 100 with more detailed information by including not only the probe information analyzing result 360 but also the message information 550 created by the user of the message information providing apparatus 500 into the response-to-request information 250.

The response-to-request information providing unit 213 transmits the response-to-request information 250 generated by the response-to-request information generating unit 212 to the information provision requesting apparatus 100.

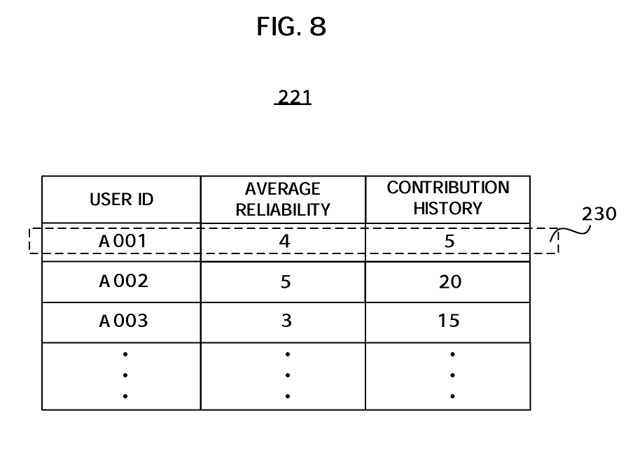

The owner reliability information updating unit 214 receives the reliability information, notified by the information provision requesting apparatus 100, of the user who transmitted the message information 550, and updates the owner reliability information DB 221 based on the reliability information. FIG. 8 shows an example of the owner reliability information DB 221. The owner reliability information DB 221 includes “USER ID” uniquely identifying the user of the message information providing apparatus 500, “AVERAGE RELIABILITY” indicating the average value of the reliability and “CONTRIBUTION HISTORY” which is a number of times of providing the message information 550.

Then, the owner reliability information updating unit 214 updates the “AVERAGE RELIABILITY” of the reliability records 230 coincident with the user, for whom the “USERID” of the owner reliability information DB 221 is notified by the information provision requesting apparatus 100, based on the reliability notified by the information provision requesting apparatus 100.

It is noted that the storage unit 203 functions as an owned device information storing means and an owner reliability information storing means, and the information provision request receiving unit 204 functions as an information provision request receiving means.

[Information Provision Requesting Process]

Next, the information provision requesting process according to the embodiment will be described.

In the information provision requesting process according to the embodiment, the information provision requesting apparatus 100 transmits the request information 150 to the information management server 200 to perform the information provision request. Thereafter, when receiving the response-to-request information 250 from the information management server 200, the information provision requesting apparatus 100 displays the response-to-request information 250 on the display unit 103.

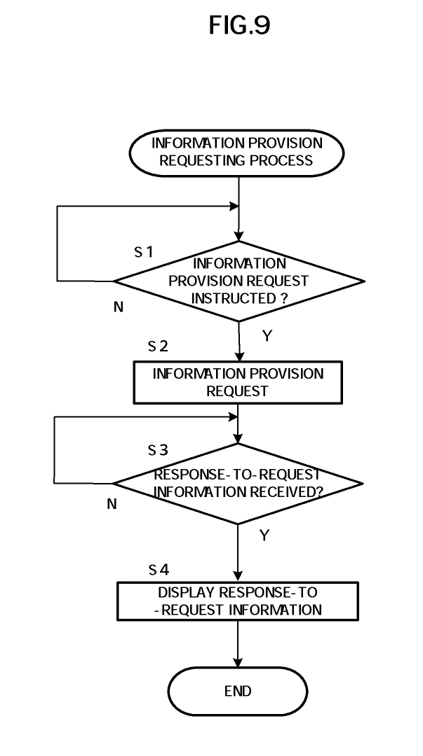

FIG. 9 shows a flowchart of the information provision requesting process according to the embodiment. This process is realized by the control unit 105 of the information provision requesting apparatus 100 executing a program prepared in advance.

First, when the control unit 105 detects that the information provision request is instructed by the input operation by the user (step S1; Yes), the information provision requesting unit 111 generates the request information 150, and transmits the information request 150 to the information management server 200 to perform the information provision request (step S2).

Then, the information obtaining unit 112 obtains the response-to-request information 250 from the information management server 200 via the transmitting/receiving unit 102 (step S3; Yes), and displays the response-to-request information 250 on the display unit 103 (step S4). Thereby, the information provision requesting process ends.

As described above, the information provision requesting apparatus 100 can obtain desired response-to-request information 250 by transmitting the request information 150 to the information management server 200 to perform the information provision request.

[Information Providing Process]

Next, the information providing process according to the embodiment will be described.

In the information providing process according to the embodiment, after receiving the information provision request from the information provision requesting apparatus 100, the information management server 200 generates the response-to-request information 250 by using the probe information 350 obtained form the probe information providing apparatus 300 and the message information 550 obtained from the message information providing apparatus 500, and provides the response-to-request information 250 to the information provision requesting apparatus 100.

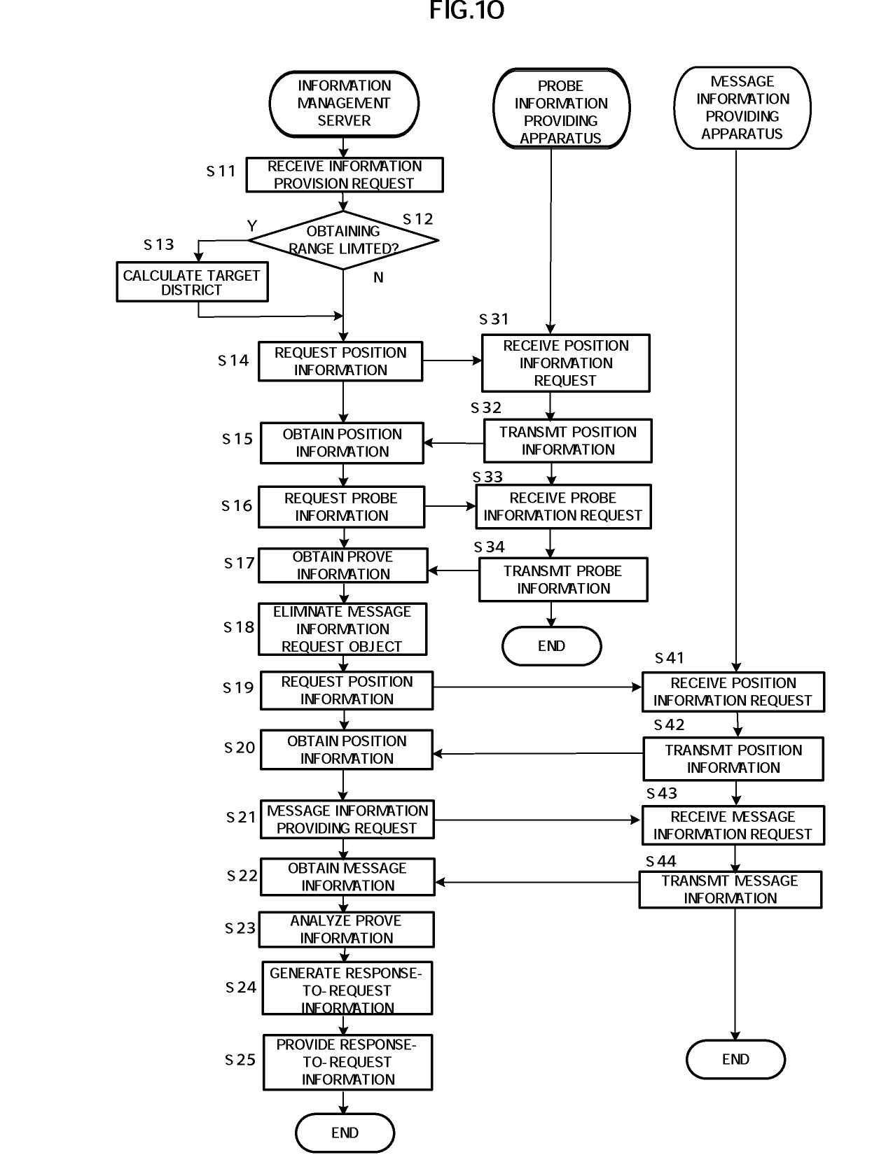

FIG. 10 shows a flowchart of the information providing process according to the embodiment. This process is realized by the control unit 201 in the information management server 200, the control unit 301 in the probe information providing apparatus 300 and the control unit 505 in the message information providing apparatus 500, each executing a program prepared in advance.

First, in the information management server 200, when the transmitting/receiving unit 202 receives the request information 150 and the information provision request from the information provision requesting apparatus 100 (step S11), the information provision receiving unit 204 determines whether the information obtaining range of the request information 150 is the district designation or the area designation (step S12).

Then, when the information obtaining range of the request information 150 is the district designation or the area designation (step S12; Yes), the information provision request receiving unit 204 determines the region of information request object by performing predetermined calculation (step S13).

Next, the requested probe information providing apparatus determining unit 205 transmits the transmission request of the position information of the probe information providing apparatus 300 to each of the probe information providing apparatuses 300 (step S14).

In the probe information providing apparatus 300, when receiving the transmission request of the position information from the information management server 200 (step S31), the current position information providing unit 306 obtains the position information (latitude and longitude information) from the GPS receiver 303, and transmits the position information to the information management server 200 via the transmitting/receiving unit 302 (step S32).

In the information management server 200, when obtaining the position information of the probe information providing apparatus 300 from the probe information providing apparatus 300 (step S15), the requested probe information providing apparatus determining unit 205 determines, by using the position information of the probe information providing apparatus 300, whether or not the probe information providing apparatus 300 is located in the region of the information request object determined by the information provision request receiving unit 204. When the probe information providing apparatus 300 is located in the range of the information obtaining range, the requested prove information providing apparatus determining unit 205 determines the probe information providing apparatus 300 as the probe information request object. It is noted that the requested probe information providing unit determining unit 205 may enlarge the region if the number of the probe information in the information obtaining range is small. Thereby, the number of the probe information that the information management server 200 obtains can be maintained.

When the information obtaining range of the request information 150 is neither the district designation nor the area designation, the requested probe information providing apparatus determining unit 205 determines all the probe information providing apparatuses 300 as the probe information request object.

In this case, it can be prevented that the information management server 200 obtains unnecessary probe information 350.

The probe information provision requesting unit 206 performs the provision request of the probe information 350 to the probe information providing apparatus 300 which is determined by the requested probe information providing apparatus determining unit 205 as the probe information request object (step S16).

In the probe information providing apparatus 300, when receiving the probe information provision request from the information management server 200 (step S33), the probe information providing unit 307 generates the probe information 350 based on the operation information of the wiper operation control device 304 and the stand-alone measurement device 305 in response to the contents of the probe information provision request, and transmits the probe information 350 to the information management server 200 via the transmitting/receiving unit 302 (step S34).

In the information management server 200, the probe information obtaining unit 207 receives the probe information 350 transmitted by the probe information providing apparatus 300 (step S17).

The requested message information providing apparatus determining unit 208 eliminates the message information providing apparatus 500 (such as a cell-phone) owned by an owner of the probe information providing apparatus 300 which has transmitted the probe information 350 from the information request object (step S18).

For example, when the requested message information providing apparatus determining unit 208 has obtained the probe information 350 from the car-navigation apparatus X which is a “probe information providing apparatus” registered in the owned device information DB 220 shown in FIG. 6, it eliminates the cell-phone A corresponding to the “message information providing apparatus” owned by the owner of the car-navigation apparatus X from the message information request object.

Thereby, the provision of the message information 550 is not further requested to the message information providing apparatus 500 owned by the owner of the probe information providing apparatus 300 (corresponding to the user ID “A001”), if the probe information providing apparatus 300 has transmitted the probe information 350. Thus, it can be prevented that unnecessary burden is put on the owner of the probe information providing apparatus 300.

Then, the requested message information providing apparatus determining unit 208 performs the position information transmission request to the message information providing apparatus 500 having a high priority order, out of the message information providing apparatuses 500 owned by the user other than the owner of the probe information providing apparatus 300 which has transmitted the probe information 350 (step S19).

For example, when the requested message information providing apparatus determining unit 208 does not receive the probe information from the car-navigation apparatus Y which is a “probe information providing apparatus 500” registered in the owned device information DB 220 shown in FIG. 6, it inquires the current position to the cell-phone B having a high priority order, out of the “message information providing apparatuses” owned by the owner of the car-navigation apparatus Y (corresponding to the user ID “A002”).

As described above, by determining the priority order in a case that the same owner owns a plurality of message information providing apparatuses, the message information transmission can be requested to the apparatus which can transmit most effective information.

In the message information providing apparatus 500, when receiving the position information transmission request from the information management server 200 (step S41), the current position information providing unit 511 obtains the position information (latitude and longitude information) from the GPS receiver 506, and transmits the position information to the information management server 200 via the transmitting/receiving unit 502 (step S42).

In the information management server 200, when receiving the position information of the message information providing apparatus 500 itself from the message information providing apparatus 500 (step S20), the requested message information providing apparatus determining unit 208 determines whether or not the message information providing apparatus 500 is located in the information obtaining range determined by the information provision request receiving unit 204, by using the position information of the message information providing apparatus 500. When the message information providing apparatus 500 is located in the information obtaining range, the requested message information providing apparatus determining unit 208 determines the message information providing apparatus as the message information request object. It is noted that, the requested probe information providing apparatus determining unit 205 determines all the probe information providing apparatuses 300 as the probe information request object, when the information obtaining range is not the area designation.

The message information provision requesting unit 209 requests the provision of the message information 550 to the message information providing apparatus 500 determined as the message information request object by the requested message information providing apparatus determining unit 208, by mail or the like (a message transmitting means such as messenger or Skype (Registered Trademark)) (step S21).

In the message information providing apparatus 500, when receiving the information providing request from the information management server 200 by mail (step S43), the message control unit 512 generates the message information 550 in accordance with the input operation by the user of the message information providing apparatus 500, and transmits the message information 550 to the information management server 200 via the transmitting/receiving unit 502 (step S44).

In the information management server 200, the message information obtaining unit 210 obtains the message information transmitted by the message information providing apparatus 500 (step S22).

The probe information analyzing unit 211 analyses the probe information 350 obtained by the probe information obtaining unit 207, and outputs the probe information analyzing result information 360 (step S23).

The response-to-request information generating unit 212 generates the response-to-request information by using the probe information analyzing result information 360 and the message information 550 (step S24). Then, the response-to-request information providing unit 213 provides the response-to-result information 250 to the information provision requesting apparatus 100 via the transmitting/receiving unit 202 (step S25). Thus, information providing process ends.

As described above, the information management server 200 includes: an information provision request receiving means which receives an information provision request, together with request information, from an information provision requesting apparatus; a requested probe information providing apparatus determining means which determines a probe information providing apparatus to which a probe information provision request is performed; a probe information provision requesting means which performs the probe information provision request to the probe information providing apparatus determined by the requested probe information providing apparatus determining means; a probe information obtaining means which obtains the probe information from the probe information providing apparatus; a requested message information providing apparatus determining means which determines a message information providing apparatus to which a message information provision request is performed; a message information provision requesting means which performs the message information provision request to the message information providing apparatus determined by the requested message information providing apparatus determining means; a message information obtaining means which obtains the message information from the message information providing apparatus; a response-to-request information generating means which generates response-to-request information corresponding to the request information by using the probe information and the message information; and a response-to-request information providing means which provides the response-to-request information to the information provision requesting apparatus.

Thus, the information management server 200 can generate the response-to-request information corresponding to the request information, by using the probe information and the message information, and provide the response-to-request information to the information provision requesting apparatus. Therefore, the information management server can provide information more specifically than the case of providing only the probe information, and can give information to the user of the information providing apparatus in an easily understand able manner.

### Other Embodiments

Although the above embodiment is directed to the case where the message information providing apparatus 500 is applied to the cell-phone, the present invention is not limited to this embodiment. The present invention may be applied to various apparatuses loaded with a GPS receiver (e.g., a personal computer).

Although the above embodiment is directed to the case where the operation state of the wiper is obtained, the present invention is not limited to this embodiment. Other information may be used as the probe information 350. Specifically, image data obtained by capturing the situation around the probe information providing apparatus 300 may be used.

Although the above embodiment is directed to the case where the probe information analyzing unit 211 includes the probe information analyzing result information 360 to the response-to-request information 250, the present invention is not limited to this embodiment. The probe information 350 itself may be included in the response-to-request information 250.

Although the above embodiment is directed to the case where the information management server 200 requests the position information to the probe information providing apparatus 300 and the message information providing apparatus 500, the present invention is not limited to this embodiment. The probe information providing apparatus 300 and the message information providing apparatus 500 may periodically transmit the position information to the information management server 200.

Although the above embodiment is directed to the case where only the message of the user of the message information providing apparatus 500 is included in the message information 550, the present invention is not limited to this embodiment. Other information such as the position information of the message information providing apparatus 500 may be included in the message information 550.

Although the above embodiment is directed to the case where the information management server 200 includes all the message information obtained from the message information providing apparatus 500 to the response-to-request information 250, the present invention is not limited to this embodiment. Only the message information 550 transmitted from a user, whose “average reliability” registered in the owner reliability information DB 221 is equal to or higher than a predetermined value, may be included in the response-to-request information 250.

In this case, since the information management server 200 includes the message information 550 of high reliability to the response-to-request information 250, the response-to-request information 250 of high quality can be provided.

Although the above embodiment is directed to the case where the probe information providing apparatus 300 is installed on a mobile body such as a vehicle, the present invention is not limited to this embodiment. The probe information providing apparatus 300 may be applied to a fixed erection such as a telegraph pole or a traffic signal.

Although the above embodiment is directed to the case where the requested probe information providing apparatus determining unit 205 obtains the position information of the probe information providing apparatus 300 from each of the probe information providing apparatus 300, the present invention is not limited to this embodiment. The requested probe information providing apparatus determining unit 105 may obtain the position of each probe information providing apparatus 300 from the probe information providing apparatus position management server 600.

In the above embodiment, if the information obtaining range of the request information 150 is the “district designation”, the information management server 200 obtains the position information of the probe information providing apparatus 300 from each probe information providing apparatus 300, and requests the provision of the probe information 350 to the probe information providing apparatus 300 which is located in the region corresponding to the above district. However, the present invention is not limited to this embodiment. The information management server 200 may obtain the information of the probe information providing apparatus 300 located in the region corresponding to the above district from the probe information providing apparatus position management server 600, thereby to request the provision of the probe information 350 to the probe information providing apparatus 300.

Although the above embodiment is directed to the case where the requested message information providing apparatus determining unit 208 obtains the position of the message information providing apparatus 500 from each message information providing apparatus 500, the present invention is not limited to this embodiment. The requested message information providing apparatus determining unit 208 may obtain the position of each of the message information providing apparatuses 500 from the cell-phone base station 700.

Although the above embodiment is directed to the case where the requested message information providing apparatus determining unit 208 obtains the position of the message information providing apparatus 500 from each of the message information providing apparatuses 500, the present invention is not limited to this embodiment. In such a case that each message information providing apparatus 500 is an apparatus located at the address of the user, e.g., a desk-top type personal computer, the position information may be determined from the address information registered in the owned device information DB 220.

### INDUSTRIAL APPLICABILITY

This invention can be used for an information providing system which provides information corresponding to an information request from an apparatus which is not located on a site.

1-9. (canceled)

10. An information management server comprising:
an information provision request receiving means which receives an information provision request, together with request information, from an information provision requesting apparatus;
a requested probe information providing apparatus determining means which determines a probe information providing apparatus to which a probe information provision request is performed;
a probe information provision requesting means which performs the probe information provision request to the probe information providing apparatus determined by the requested probe information providing apparatus determining means;
a probe information obtaining means which obtains the probe information from the probe information providing apparatus;
a requested message information providing apparatus determining means which determines a message information providing apparatus to which a message information provision request is performed;
a message information provision requesting means which performs the message information provision request to the message information providing apparatus determined by the requested message information providing apparatus determining means;
a message information obtaining means which obtains the message information from the message information providing apparatus;
a response-to-request information generating means which generates response-to-request information corresponding to the request information by using the probe information and the message information; and
a response-to-request information providing means which provides the response-to-request information to the information provision requesting apparatus.

11. The information management server according to claim 10,
wherein the request information limits an information obtaining range,
wherein the information provision request receiving means determines a region corresponding to the information obtaining range,
wherein the requested probe information providing apparatus determining means determines the prove information providing apparatus located in the region as the probe information providing apparatus to which the probe information provision request is performed, and
wherein the requested message information providing apparatus determining means determines the message information providing apparatus located in the region as the message information providing apparatus to which the message information provision request is performed.

12. The information management server according to claim 10, further comprising an owned device information storing means which stores owned device information defining correspondence between the probe information providing apparatus and an owner of the probe information providing apparatus and correspondence between the message information providing apparatus and an owner of the message information providing apparatus,
wherein the requested message information providing apparatus determining means refers to the owned device information and eliminates the message information providing apparatus, owned by the owner of the probe information providing apparatus which has provided the probe information, from an object of the information provision request.

13. The information management server according to claim 12,
wherein the owned device information includes an priority order for a plurality of the message information providing apparatuses owned by a same owner, and
wherein the requested message information providing apparatus determining means determines whether or not to perform the information provision request to the message information providing apparatus having high priority order in the owned device information when the same owner owns the plurality of the message information providing apparatuses.

14. The information management server according to claim 12, further comprising:
an owner reliability information storing means which stores owner reliability information defining correspondence between the owner of the message information providing apparatus which transmitted the message information and reliability of the message information, and
an owner reliability information updating means which updates the owner reliability information based on reliability information defining the reliability of the message information in the response-to-request information,
wherein the response-to-request information generating means selects the message information to be included in the response-to-request information based on the owner reliability information.

15. An information management method comprising:
an information provision request receiving process which receives an information provision request, together with request information, from an information provision requesting apparatus;
a requested probe information providing apparatus determining process which determines a probe information providing apparatus to which a probe information provision request is performed;
a probe information provision requesting process which performs the probe information provision request to the probe information providing apparatus determined by the requested probe information providing apparatus determining process;
a probe information obtaining process which obtains the probe information from the probe information providing apparatus;
a requested message information providing apparatus determining process which determines a message information providing apparatus to which a message information provision request is performed;
a message information provision requesting process which performs the message information provision request to the message information providing apparatus determined by the requested message information providing apparatus determining process;
a message information obtaining process which obtains the message information from the message information providing apparatus;
a response-to-request information generating process which generates response-to-request information corresponding to the request information by using the probe information and the message information; and
a response-to-request information providing process which provides the response-to-request information to the information provision requesting apparatus.

16. A computer program product stored in a computer-readable medium for an information management executed by an apparatus including a computer, the program makes the computer function as:
an information provision request receiving means which receives an information provision request, together with request information, from an information provision requesting apparatus;
a requested probe information providing apparatus determining means which determines a probe information providing apparatus to which a probe information provision request is performed;
a probe information provision requesting means which performs the probe information provision request to the probe information providing apparatus determined by the requested probe information providing apparatus determining means;
a probe information obtaining means which obtains the probe information from the probe information providing apparatus;
a requested message information providing apparatus determining means which determines a message information providing apparatus to which a message information provision request is performed;
a message information provision requesting means which performs the message information provision request to the message information providing apparatus determined by the requested message information providing apparatus determining means;
a message information obtaining means which obtains the message information from the message information providing apparatus;
a response-to-request information generating means which generates response-to-request information corresponding to the request information by using the probe information and the message information; and
a response-to-request information providing means which provides the response-to-request information to the information provision requesting apparatus.

17. An information providing system comprising an information provision requesting apparatus, an information management server, a probe information providing apparatus and a message information providing apparatus,
wherein the information provision requesting apparatus comprises:
an information provision requesting means which performs an information provision request, together with request information, to the information management server; and
a response-to-request information obtaining means which obtains response-to-request information corresponding to the request information from the information management server,
wherein the information management server comprises:
an information provision request receiving means which receives the information provision request, together with the request information, from the information provision requesting apparatus;
a requested probe information providing apparatus determining means which determines the probe information providing apparatus to which a probe information provision request is performed;
a probe information provision requesting means which performs the probe information provision request to the probe information providing apparatus determined by the requested probe information providing apparatus determining means;
a probe information obtaining means which obtains the probe information from the probe information providing apparatus;
a requested message information providing apparatus determining means which determines the message information providing apparatus to which a message information provision request is performed;
a message information provision requesting means which performs the message information provision request to the message information providing apparatus determined by the requested message information providing apparatus determining means;
a message information obtaining means which obtains the message information from the message information providing apparatus;
a response-to-request information generating means which generates response-to-request information corresponding to the request information by using the probe information and the message information; and
a response-to-request information providing means which provides the response-to-request information to the information provision requesting apparatus,
wherein the probe information providing apparatus comprises a probe information providing means which provides probe information in response to the probe information provision request from the information management server, and
wherein the message information providing apparatus comprises a message information providing means which provides message information in response to the message information provision request from the information management server.
